(19) United States
(12) Patent Application Publication
(10) Pub. No.: US 2007/0091586 A1
(43) Pub. Date: Apr. 26, 2007

(54) Illuminant device

(75) Inventor: Hui-Tung Huang, Kaohsiung City (TW)

Correspondence Address: LADAS & PARRY, 26 WEST 61ST STREET, NEW YORK, NY, 10023, US

(73) Assignees: POLARLITE CORPORATION; FIRST LITE CORPORATION

(21) Appl. No.: 11/327,800

(22) Filed: Jan. 6, 2006

(30) Foreign Application Priority Data
Oct. 21, 2005 (TW) 094137005

(51) Int. Cl. G09F 13/04

(52) U.S. Cl. 362/97; 362/632

(57) ABSTRACT

The invention relates to an illuminant device. The illuminant device of the invention comprises a base, a connecting portion, a containing portion, a sheet-like light source and a closing element. The base has a rib. The connecting portion has a first combining portion, and the shape of the first combining portion matches with the shape of the rib. The connecting portion is disposed on the rib by using the first combining portion. The containing portion has a second combining portion and at least one transparent surface. The containing portion is disposed on the rib by using the second combining portion and connects to the connecting portion. The sheet-like light source is disposed in the containing portion and the light comes out from the transparent surface. The closing element is used to close the containing portion. Whereby, the illuminant device of the invention can be set up at any location to be marked or advertised for achieving quite a remarkable or advertising effect. Furthermore, the size of the components of the illuminant device is small so that it occupies less space. Moreover, the elements of the illuminant device of the invention are simple and easy to assemble.

### BACKGROUND OF THE INVENTION

1. Field of the invention

The present invention relates to an illuminant device, particularly to an illuminant device having a sheet-like light source.

2. Description of the Related Art

In the recent years, the opto electronics industry develops very fast, and every kind of illuminant device weeds through the old to bring forth the new; however, the present illuminant device is usually spherical or cylindrical, and the light source is a point source or line source, for example, a light bulb and a fluorescent light, shown as FIG. 1. Up to the present, the LED is also one type of point source or the line source. Although the liquid crystal display device (LCD) of a computer is a surface source, a plurality of thin and long fluorescent lights are used with transparent refraction plates to form the surface source. Therefore, the conventional illuminant device I has complex elements, and because the light source of the conventional illuminant device is a light bulb or a fluorescent light 10, the conventional illuminant device has a bigger size and occupies more space.

Consequently, there is an existing need for an illuminant device to solve the above-mentioned problems.

### SUMMARY OF THE INVENTION

One objective of the present invention is to provide an illuminant device comprising a base, a connecting portion, a containing portion, a sheet-like light source and a closing element. The base has a rib, the connecting portion has a first combining portion, and the shape of the first combining portion matches with the shape of the rib. The connecting portion is disposed on the rib by using the first combining portion. The containing portion has a second combining portion and at least one transparent surface. The containing portion is disposed on the rib by using the second combining portion and connects to the connecting portion. The sheet-like light source is disposed in the containing portion and the light comess out from the transparent surface. The closing element is used to close the containing portion.

Another objective of the present invention is to provide an illuminant device comprising at least one base, a connecting portion, a plurality of containing portions, at least one connecting device, at least two sheet-like light sources and at least one closing element. The base has a rib. The connecting portion has a first combining portion, and the shape of the first combining portion matches with the shape of the rib. The connecting portion is disposed on the rib by using the first combining portion. The containing portions comprise a first containing portion and a second containing portion. The first containing portion has a second combining portion and at least one first transparent surface. The first containing portion is disposed on the rib by the second combining portion and connects to the connecting portion.

The second containing portion has a third combining portion and at least one second transparent surface. The second containing portion is disposed on the rib by using the third combining portion. The connecting device is disposed between the first containing portion and the second containing portion. The connecting device connects the first containing portion and the second containing portion, and it is disposed on the rib.

The sheet-like light sources are respectively disposed in the first containing portion and the second containing portion, and the light comes out from the first transparent surface and the second transparent surface. The closing element is used to close the containing portion.

The illuminant device of the invention can be set up at any location to be marked or advertised for achieving quite a remarkable advertising effect. Furthermore, the size of the components of the illuminant device is small so that it occupies less space. Moreover, the elements of the illuminant device of the invention are simple and easy to assemble.

### BRIEF DESCRIPTION OF THE DRAWINGS

FIG. 1 shows a conventional illuminant device;

FIG. 2 shows an exploded view of an illuminant device according to a first embodiment of the present invention;

FIG. 3 shows an assembly view of an illuminant device according to a first embodiment of the present invention;

FIG. 4 an exploded view of an illuminant device according to a second embodiment of the present invention;

FIG. 5 shows an assembly view of an illuminant device according to a first embodiment of the present invention;

FIGS. 6 to 8 show an illuminant device of the present invention in different applications; and

FIG. 9 shows another type of the connecting device of the present invention.

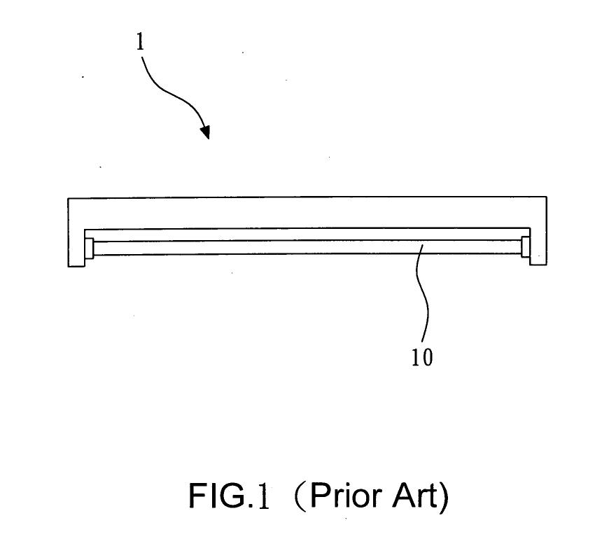

### DETAILED DESCRIPTION OF THE INVENTION

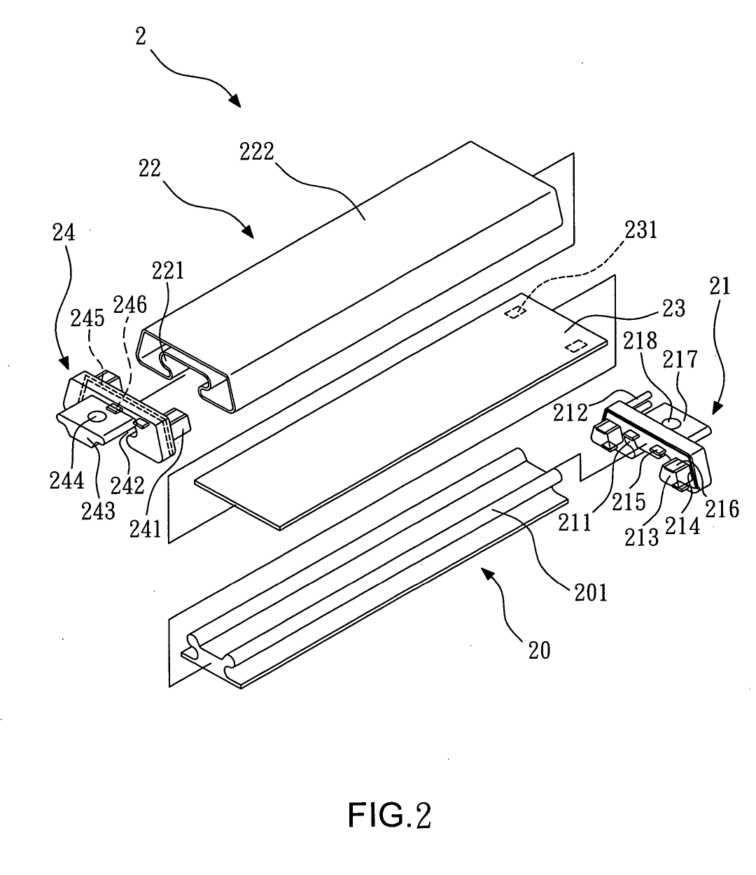

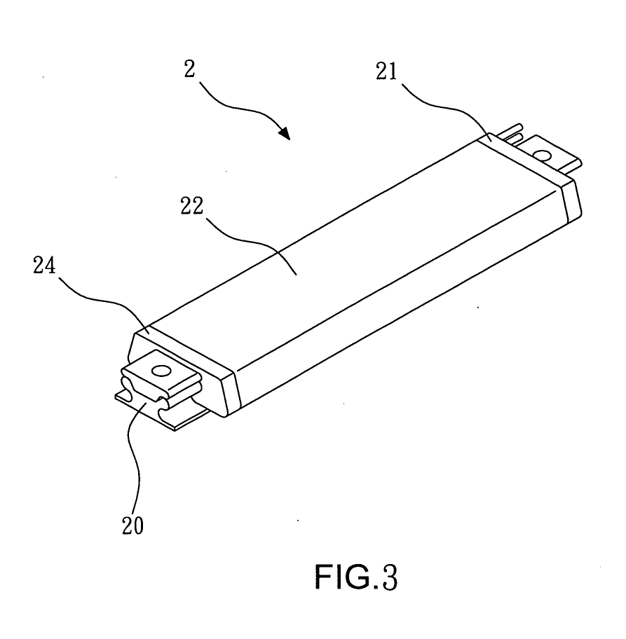

Referring to FIGS. 2 and 3, according to a first embodiment of the present invention, the illuminant device 2 comprises a base 20, a connecting portion 21, a containing portion 22, a sheet-like light source 23 and a closing element 24. The base 20 has a rib 201. The connecting portion 21 has a first combining portion 211, a power terminal 212, two first fixing portions 213, a groove 214 and a plurality of lip structures 215. The shape of the first combining portion 211 matches with the shape of the rib 201. The connecting portion 21 is disposed on the rib 201 by using the first combining portion 211.

The first fixing portions 213 are used to carry and fix the sheet-like light source 23, and connect with the containing portion 22. The connecting portion 21 is made of a flexible material so that it can connect with the containing portion 22 very well. Each first fixing portion 213 has a first conducting portion 216, and the first conducting portion 216 electrically connects with the power terminal 212. The connecting portion 21 further has a first extrusion portion 217, and the first extrusion portion 217 has a first opening 218. The first opening 218 is used to receive screw and to fix the connecting portion 21 on the base 20. The shape of the groove 214 matches with the shape of the containing portion 22, and the containing portion 22 is disposed in the groove 214 and fixed by using the groove 214. The lip structures 215 operate in coordination with the groove 214 to enhance the connection of the containing portion 22 and support the containing portion 22.

The containing portion 22 has a second combining portion 221 and at least one transparent surface 222. The shape of the second combining portion 221 matches with the shape of the rib 201, and the containing portion 22 is disposed on the rib 201 by using the second combining portion 221 and connects to the connecting portion 21. The sheet-like light source 23 is disposed in the containing portion 22 and the light comes out from the transparent surface 222. The sheet-like light source 23 further has two electrodes 231. The electrodes 231 are disposed on the corresponding first conducting portions 216, and electrically connect with the first conducting portions 216. The sheet-like light source 23 can be a so-called sheet-like illuminant material, for example, LED, CCFL, EL or OLED/PLED.

The closing element 24 has two second fixing portions 241, a third combining portion 242 and a second extrusion portion 243. The second fixing portions 241 are used to carry and fix the sheet-like light source 23 and connect with the containing portion 22 so as to close the containing portion 22. The shape of the third combining portion 242 matches with the shape of the rib 201, and the closing element 24 is disposed on the rib 201 by using the third combining portion 242. The closing element 24 is made of a flexible material so that it can connect with the containing portion 22 very well. The second extrusion portion 243 has a second opening 244, and the second opening 244 is used to receive and to fix the closing element 24 on the base 20. The closing element 24 further has a groove 245 and a plurality of lip structures 246. The shape of the groove 245 matches with the shape of the containing portion 22, and the containing portion 22 is disposed in the groove 245 and fixed by using the groove 245. The lip structures 246 operate in coordination with the groove 245 to enhance the connection of the containing portion 22 and support the containing portion 22.

In addition, according to the first embodiment of the present invention, the illuminant device 2 further comprises a color film that is disposed between the sheet-like light source 23 and the transparent surface 222. The color film can be a transparent film in any color so that the light of the sheet-like light source 23 can change color to increase the visual effect and identification.

In the illuminant device 2 of the first embodiment, the light of the sheet-like light source 23 comes out from the transparent surface 222; therefore, the illuminant device 2 of the invention can be set up at any location to be marked or advertised for achieving quite a remarkable advertising effect. Furthermore, the sheet-like light source 23 is very thin, and the size of the base 20, the containing portion 22 and the closing element 24 can be very small. Therefore, the size of the components of the illuminant device 2 is small so that it occupies less space. Moreover, the elements of the illuminant device 2 of the invention are simple and easy to assemble.

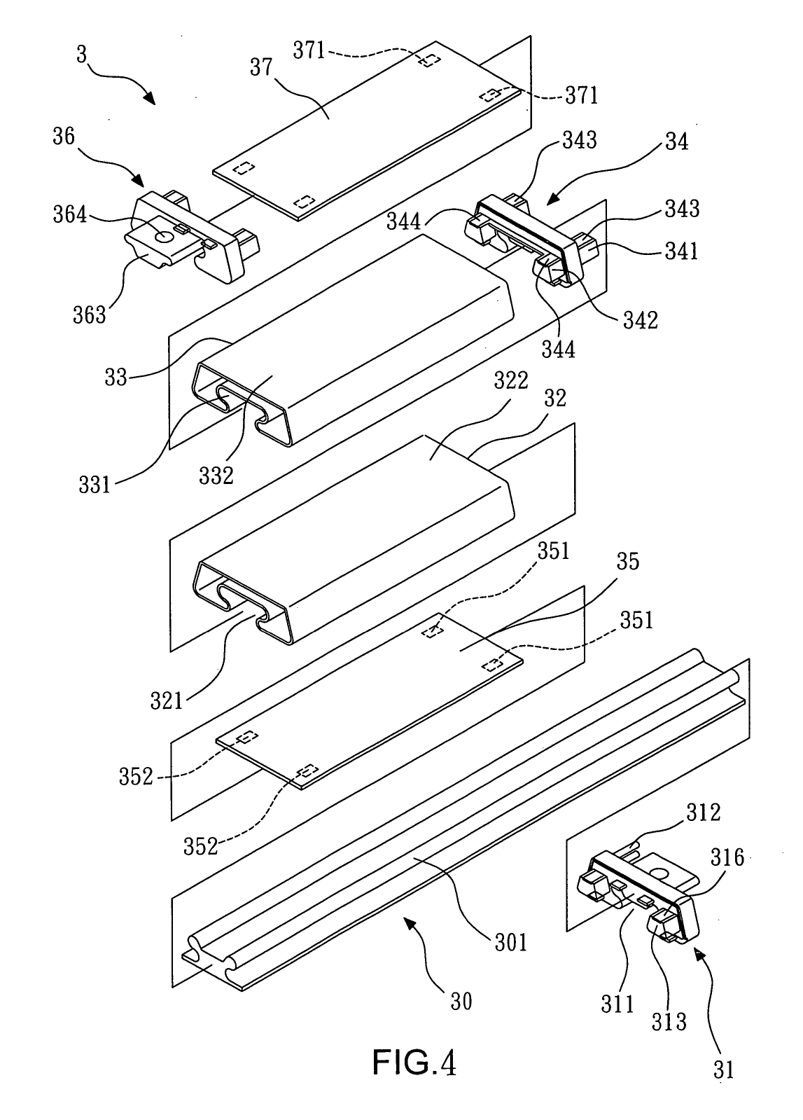

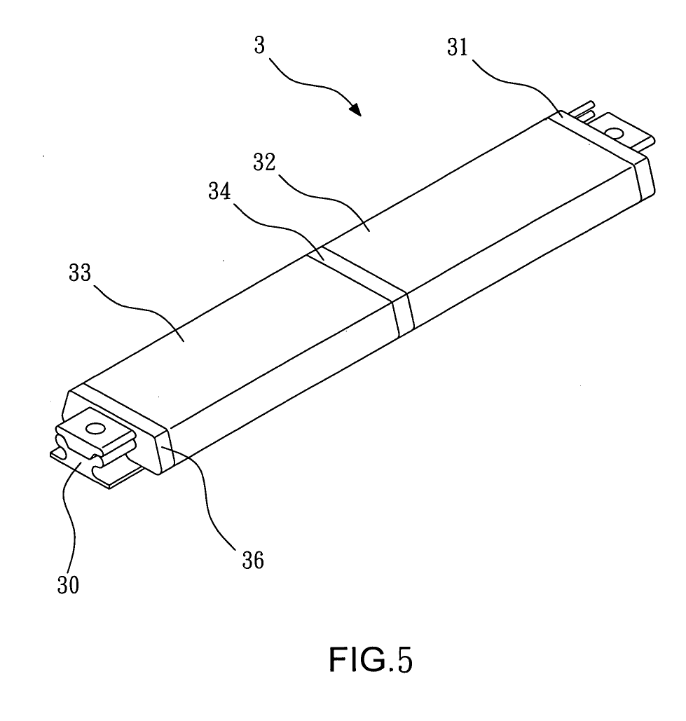

Referring to FIGS. 4 and 5, according to a second embodiment of the present invention, the illuminant device 3 comprises a base 30, a connecting portion 31, a first containing portion 32, a second containing portion 33, a connecting device 34, two sheet-like light sources 35, 37 and a closing element 36. The base 30 has a rib 301. The connecting portion 31 has a first combining portion 311, a power terminal 312 and two first fixing portions 313. Each first fixing portion 313 has a first conducting portion 316, and the first conducting portion 316 electrically connects with the power terminal 312. In the second embodiment, the structures of the base 30, the connecting portion 31 and the closing element 36 are the same with the structures of base 20, the connecting portion 21 and the closing element 26 in the first embodiment, and thus they will not be described in detail.

The first containing portion 32 has a second combining portion 321 and at least one first transparent surface 322. The first containing portion 32 is disposed on the rib 301 by using the second combining portion 321 and connects to the connecting portion 31. The second containing portion 33 has a third combining portion 331 and at least one second transparent surface 332. The second containing portion 33 is disposed on the rib 301 by using the third combining portion 331.

The connecting device 34 is disposed between the first containing portion 32 and the second containing portion 33. The connecting device 34 is fixed on the rib 301 and is used to connect the first containing portion 32. The connecting device 34 has two second fixing portions 341, at least one couple of third fixing portions 342, a second conducting portion 343 and a third conducting portion 344. The second conducting portion 343 is disposed on one surface of each second fixing portion 341, and the third conducting portion 344 is disposed on the surfaces of the couple of the third fixing portions 342. The second conducting portion 343 electrically connects with the third conducting portion 344. The second fixing portions 341 and the third fixing portions 342 are used to carry and fix the sheet-like light source 35, 37, and connects with the first containing portion 32 and the second containing portion 33. It is to be noticed that the connecting device 34 can also be used to close the second containing portion 33.

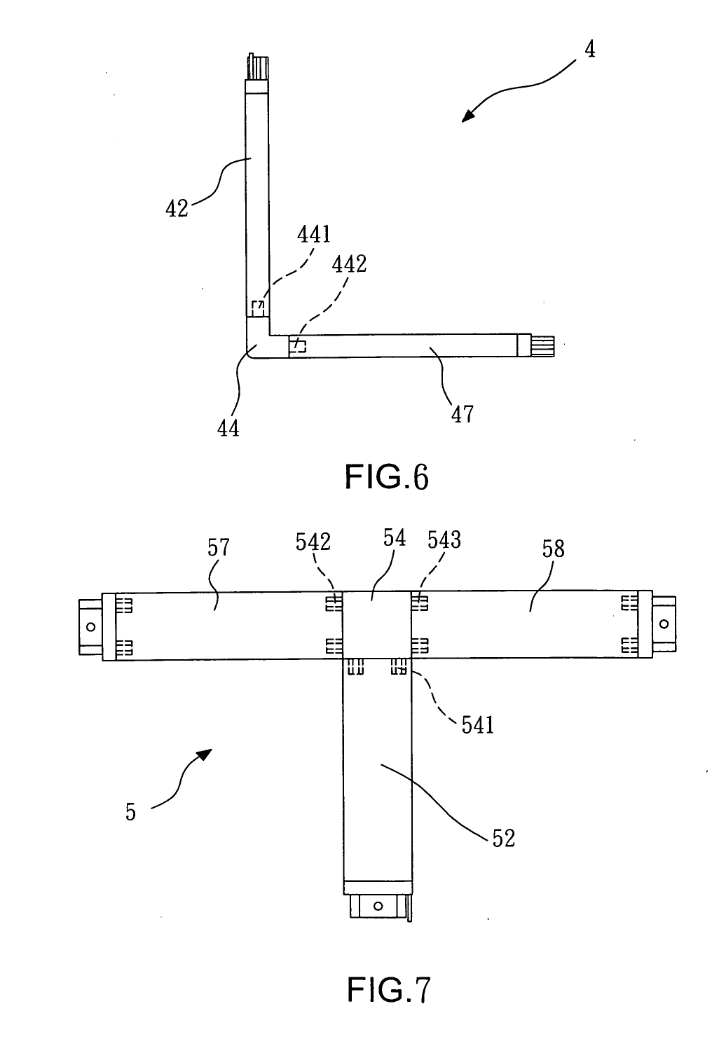

Referring to FIG. 6, the connecting device 44 can also be L-shaped. In the embodiment, the second fixing portions 441 and the third fixing portions 442 form a L-shaped structure, and a plurality of containing portions 42, 47 respectively connect with the second fixing portions 441 and the third fixing portions 442 so that the illuminant device 4 is also L-shaped.

Referring to FIG. 7, the connecting device 54 can also be T-shaped. In the embodiment, the connecting device 54 has two second fixing portions 541 and two couples of third fixing portions 542, 543. The third fixing portions 542, 543 are in a line and perpendicular to the second fixing portions 541. The second fixing portions 541 and the third fixing portions 542, 543 form a T-shaped structure, and a plurality of containing portions 52, 57, 58 respectively connect with the second fixing portions 441 and the third fixing portions 542, 543 so that the illuminant device 5 is also T-shaped.

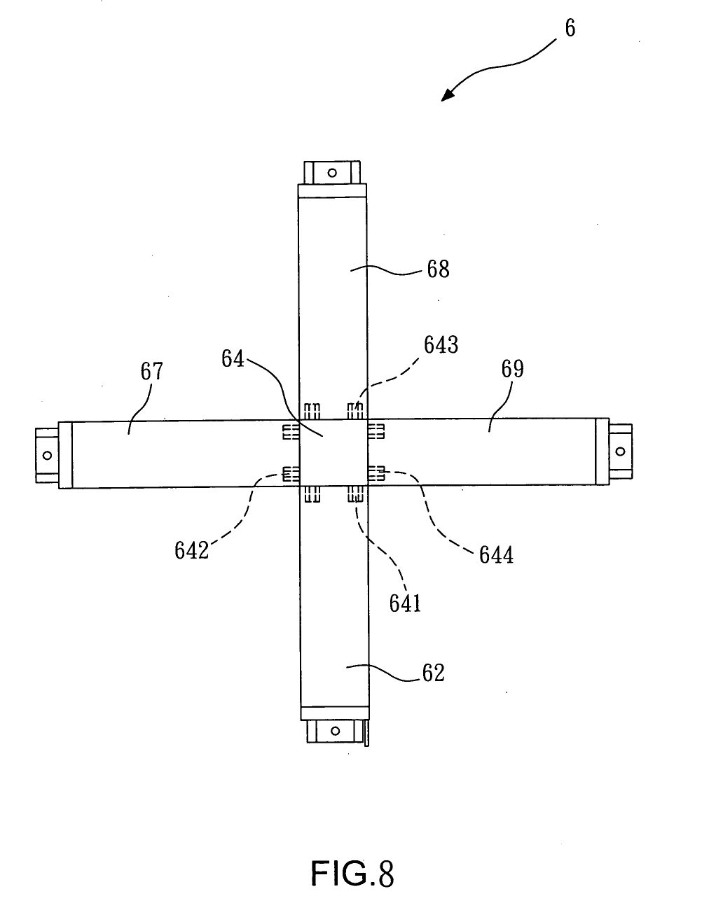

Referring to FIG. 8, the connecting device 64 can also be cross-shaped. In the embodiment, the connecting device 64 has two second fixing portions 641 and three couples of third fixing portions 642, 643, 644. The third fixing portions 642, 643, 644 and the second fixing portions 641 form a cross-shaped structure, and a plurality of containing portions 62, 67, 68, 69 respectively connect with the second fixing portions 641 and the third fixing portions 62, 67, 68, 69 so that the illuminant device 6 is also cross-shaped.

Referring to FIGS. 4 and 5 again, the sheet-like light sources 35, 37 are respectively disposed in the first containing portion 32 and the second containing portion 33. The sheet-like light source 35 has a plurality of electrodes 351, 352. The electrodes 351 electrically connect with the first conducting portions 316 of the connecting portion 31, and the electrodes 352 electrically connect with the second conducting portions 343 of the connecting device 34. The light comes out from the first transparent surface 322. The sheet-like light source 37 has a plurality of electrodes 371. The electrodes 371 electrically connect with the third conducting portions 344 of the connecting device 34, and the light comes out from the second transparent surface 332.

The sheet-like light sources 35, the connecting portion 31 and the sheet-like light sources 37 are in serial connection. It is understood that in the T-shaped or cross-shaped illuminant device, the electrodes 351, 352 can respectively electrically connect with the first conducting portions 316 of the connecting portion 31 and the second conducting portions 343 of the connecting device 34, and electrodes 371 electrically connect with the third conducting portions 344 of the connecting portion 31 so that the sheet-like light sources 35, the connecting portion 31 and the sheet-like light sources 37 are in parallel connection.

The closing element 36 is made of a flexible material so that it can connect with the second containing portion 33 very well. The second extrusion portion 363 has a second opening 3644, and the second opening 364 is used to fix the closing element 36 on the base 30.

In addition, according to the second embodiment of the present invention, the illuminant device 3 further comprises color films that are respectively disposed between the sheet-like light source 35 and the first transparent surface 322 and between the sheet-like light source 37 and the second transparent surface 332. The color films can be transparent films in any color so that the light of the sheet-like light sources 35, 37 can change color to increase the visual effect and identification.

In the illuminant device 3 of the second embodiment, the light of the sheet-like light sources 35, 37 that comes out from the first transparent surface 322 and the second transparent surface 332 not only is easily identified but also achieves quite a remarkable or advertising effect. Furthermore, the size of the illuminant device 3 is very small and it occupies less space. Moreover, using the connecting device 34 can obtain the designed length of the illuminant device 3.

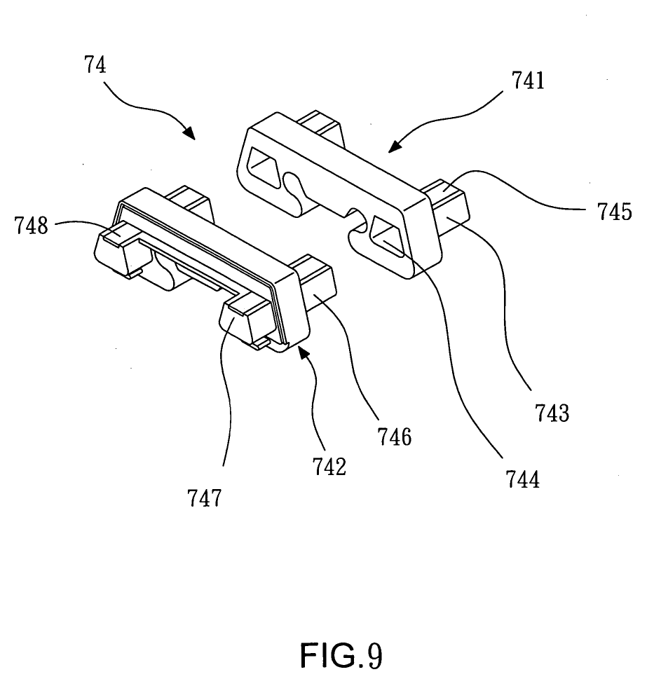

FIG. 9 shows another type of the connecting device of the present invention. The connecting device 74 has a first part 741 and a second part 742. The first part 741 has two fourth fixing portions 743, two fixing holes 744 and a third conducting portion 745. The third conducting portion 745 is disposed on the fourth fixing portions 743 and extends into the fixing holes 744. The second part 742 has two fifth fixing portions 746, at least one couple of sixth fixing portions 747 and a fourth conducting portion 748. The fourth conducting portion 748 is disposed on the surfaces of the fifth fixing portions 746 and the sixth fixing portions 747. The fifth fixing portions 746 are disposed in the fixing holes 744, and the fourth conducting portion 748 electrically connects with the third conducting portion 745. Although the connecting device 74 is H-shaped, it is to be noticed that the connecting device 74 can also be L-shaped, T-shaped or cross-shaped.

The connecting device 74 connects with a plurality of containing portions to form a line-shaped, L-shaped, T-shaped or cross-shaped structure. Because the connecting device 74 comprises the first part 741 and the second part 742, by utilizing the connecting device 74, the structure type of the illuminant device can be changed arbitrarily. Moreover, using the connecting device 74 to connect the sheet-like light sources and the containing portions can obtain the designed length of the illuminant device arbitrarily.

Whereby, the illuminant device of the invention can be set up at any location to be marked (for example, a threshold, a corner formed by two walls, stairs and pavements etc.) or advertised for achieving quite a remarkable advertising effect. Furthermore, the size of the components of the illuminant device is small so that it occupies less space. Moreover, the elements of the illuminant device of the invention are simple and easy to assemble.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An illuminant device comprising:
a base, having a rib;
a connecting portion, having a first combining portion, the shape of the first combining portion matching with the shape of the rib, and the connecting portion disposed on the rib by using the first combining portion;
a containing portion, having a second combining portion and at least one transparent surface, and the containing portion disposed on the rib by using the second combining portion and connecting to the connecting portion;
a sheet-like light source, disposed in the containing portion, and the light coming out from the transparent surface; and
a closing element, used to close the containing portion.

2. The illuminant device according to claim 1, wherein the connecting portion further comprises a power terminal and two first fixing portions, the first fixing portions used to carry and fix the sheet-like light source and connecting with the containing portion, each first fixing portion having a first conducting portion electrically connecting with the power terminal.

3. The illuminant device according to claim 2, wherein the sheet-like light source further comprises two electrodes disposed on one surface of the sheet-like light source, and the electrodes electrically connecting with the first conducting portions.

4. The illuminant device according to claim 2, wherein the connecting portion further comprises a first extrusion portion having a first opening, and the opening used to receive screw and to fix the connecting portion on the base.

5. The illuminant device according to claim 2, wherein the connecting portion further comprises a groove and a plurality of lip structures, the shape of the groove matching with the shape of the containing portion, the containing portion disposed in the groove and fixed by using the groove, and the lip structures operating in coordination with the groove to enhance the connection of the containing portion and supporting the containing portion.

6. The illuminant device according to claim 1, wherein the closing element further comprises two second fixing portions and a second extrusion portion, the second fixing portions used to carry and fix the sheet-like light source and connecting with the containing portion, and the second extrusion portion having a second opening used to receive screw and to fix the closing element on the base.

7. The illuminant device according to claim 1, wherein the closing element further comprises a groove and a plurality of lip structures, the shape of the groove matching with the shape of the containing portion, the containing portion disposed in the groove and fixed by using the groove, and the lip structures operating in coordination with the groove to enhance the connection of the containing portion and supporting the containing portion.

8. An illuminant device comprising:
at least one base, each base having a rib;
a connecting portion, having a first combining portion, the shape of the first combining portion matching with the shape of the rib, and the connecting portion disposed on the rib by using the first combining portion;
a plurality of containing portions, having a first containing portion and a second containing portion, the first containing portion having a second combining portion and at least one first transparent surface, and disposed on the rib by using the second combining portion and connecting to the connecting portion, the second containing portion having a third combining portion and at least one second transparent surface, and disposed on the rib by using the third combining portion;
at least one connecting device, disposed between the first containing portion and the second containing portion, connecting the first containing portion and the second containing portion, and fixed on the rib;
at least two sheet-like light sources, respectively disposed in the first containing portion and the second containing portion, and the light coming out from -the first transparent surface and the second transparent surface; and
at least one closing element, used to close the second containing portion.

9. The illuminant device according to claim 8, wherein the connecting portion further comprises a power terminal and two first fixing portions, the first fixing portions used to carry and fix the sheet-like light source and connecting with the containing portion, each first fixing portion having a first conducting portion electrically connecting with the power terminal.

10. The illuminant device according to claim 8, wherein the connecting device can be used to close the second containing portion.

11. The illuminant device according to claim 8, wherein the connecting device further comprises two second fixing portions, at least one couple of third fixing portions and a second conducting portion, the second conducting portion disposed on surfaces of the second fixing portions and the third fixing portions, the second fixing portions and the third fixing portions used to carry and fix the sheet-like light sources and connecting with the containing portions.

12. The illuminant device according to claim 11, wherein each sheet-like light source further comprises a plurality of electrodes respectively electrically connecting with the first conducting portions and the second conducting portions in serial connection.

13. The illuminant device according to claim 11, wherein each sheet-like light source further comprises a plurality of electrodes respectively electrically connecting with the first conducting portions and the second conducting portions in parallel connection.

14. The illuminant device according to claim 11, wherein the connecting device is L-shaped.

15. The illuminant device according to claim 11, wherein the connecting device is T-shaped.

16. The illuminant device according to claim 11, wherein the connecting device is cross-shaped.

17. The illuminant device according to claim 8, wherein the connecting device further comprises a first part and a second part, the first part having two fourth fixing portions, two fixing holes and a third conducting portion, the third conducting portion disposed on the fourth fixing portions and extending into the fixing holes, the second part having two fifth fixing portions, at least one couple of sixth fixing portions and a fourth conducting portion, the fourth conducting portion disposed on surfaces of the fifth fixing portions and the sixth fixing portions, the fifth fixing portions disposed in the fixing holes, and the fourth conducting portion electrically connecting with the third conducting portion.

18. The illuminant device according to claim 17, wherein the connecting device is L-shaped.

19. The illuminant device according to claim 17, wherein the connecting device is T-shaped.

20. The illuminant device according to claim 17, wherein the connecting device is cross-shaped.

21. The illuminant device according to claim 22, wherein each sheet-like light source further comprises a plurality of electrodes respectively electrically connecting with the first conducting portions of the connecting portion, and the second conducting portions and third conducting portions of the connecting device in serial connection.

22. The illuminant device according to claim 17, wherein each sheet-like light source further comprises a plurality of electrodes respectively electrically connecting with the first conducting portions of the connecting portion, and the second conducting portions and third conducting portions of the connecting device in parallel connection.

23. The illuminant device according to claim 8, wherein the connecting portion further comprises a first extrusion portion having a first opening, and the opening used to receive screw and to fix the connecting portion on the base.

24. The illuminant device according to claim 8, wherein the connecting portion further comprises a groove and a plurality of lip structures, the shape of the groove matching with the shape of the containing portion, the containing portion disposed in the groove and fixed by using the groove, and the lip structures operating in coordination with the groove to enhance the connection of the containing portion and supporting the containing portion.

25. The illuminant device according to claim 8, wherein the closing element further comprises two second fixing portions and a second extrusion portion used to carry and fix the sheet-like light source and connecting with the containing portion, and the second extrusion portion having a second opening used to receive screw and to fix the closing element on the base.

26. The illuminant device according to claim 8, wherein the closing element further comprises a groove and a plurality of lip structures, the shape of the groove matching with the shape of the containing portion, the containing portion disposed in the groove and fixed by using the groove, and the lip structures operating in coordination with the groove to enhance the connection of the containing portion and supporting the containing portion.
